(19) United States
(12) Patent Application Publication
(10) Pub. No.: US 2014/0052372 A1
(43) Pub. Date: Feb. 20, 2014

(54) METHODS, APPARATUSES, AND COMPUTER PROGRAM PRODUCTS FOR MODIFICATION OF ROUTES BASED ON USER INPUT

(71) Applicant: Bernard Berus, Berlin (DE)

(72) Inventor: Bernard Berus, Berlin (DE)

(73) Assignee: Nokia Corporation, Espoo (FI)

(21) Appl. No.: 13/587,524

(22) Filed: Aug. 16, 2012

(51) Int. Cl. G01C 21/34

(52) U.S. Cl. CPC G01C 21/3461
USPC 701/533

(57) ABSTRACT

Methods, apparatuses, and computer program products are herein provided for modification of routes based on user input. A method may include causing calculation of a route in a map. The method may further include receiving input indicating a location along the route and a user preference associated with avoidance of the location. The method may further include determining, based at least in part on the input, a modification to the route. Corresponding apparatuses and computer program products are also provided.

### TECHNOLOGICAL FIELD

An example embodiment of the present invention relates generally to user interface technology and, more particularly, relates to methods, apparatuses, and computer program products for modification of routes based on user input.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

### BRIEF SUMMARY

Example embodiments of the present invention provide for modification of routes based on user input. In one example embodiment, a method includes causing calculation of a route in a map. The method further includes receiving input indicating a location along the route and a user preference associated with avoidance of the location. The method further includes determining, by a processor, based at least in part on the input, a modification to the route.

In some embodiments, the method may include receiving input indicating the location along the route and the user preference associated with avoidance of the location by receiving input indicating a desired degree of avoidance of the location. Additionally, the method may include determining the modification to the route by determining the modification to the route based at least in part on the desired degree of avoidance of the location. In some embodiments, the method may include receiving input by receiving user input comprising a point and twist gesture. Additionally, the degree of the twist of the user input may indicate the desired degree of avoidance of the location. In some embodiments, the method may include receiving input by receiving user input comprising at least one of a reverse pinch gesture or a slide gesture.

In some embodiments, the method may include receiving input indicating the location along the route and the user preference associated with avoidance of the location by receiving input indicating at least one of a desired point of interest to pass by or a desire to travel on a road that includes less traffic.

In some embodiments, the method may include determining the modification to the route by determining a modification to a portion of the route within a proximity of the location, wherein the proximity is determined based on the user preference associated with avoidance of the location.

In some embodiments, the method may further comprise prompting the user to indicate a desired degree of avoidance of the location in response to receiving the first input. Additionally, in some embodiments, the method may include determining the modification to the route by determining the modification to the route based at least in part on the desired degree of avoidance of the location.

In some embodiments, the method may further comprise, in response to receiving the input, cause display of a list of modified routes for a user to select from.

In some embodiments, the method may further comprise causing presentation of the route on the map. Additionally, in some embodiments, the method may further comprise causing presentation of the route on the map to be modified based on the determined modification to the route.

In another example embodiment, an apparatus comprises at least one processor and at least one memory storing computer program code with the at least one memory and stored computer program code being configured, with the at least one processor, to cause the apparatus to cause calculation of a route in a map. The at least one memory and stored computer program code are configured, with the at least one processor, to further cause the apparatus to receive input indicating a location along the route and a user preference associated with avoidance of the location. The at least one memory and stored computer program code are configured, with the at least one processor, to further cause the apparatus to determine, based at least in part on the input, a modification to the route.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including causing calculation of a route in a map. The method further includes receiving input indicating a location along the route and a user preference associated with avoidance of the location. The method further includes determining, based at least in part on the input, a modification to the route.

In another example embodiment, an apparatus is provided. The apparatus comprises means for causing calculation of a route in a map. The apparatus further comprises means for receiving input indicating a location along the route and a user preference associated with avoidance of the location. The apparatus further comprises means for determining, based at least in part on the input, a modification to the route.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus according to an example embodiment of the present invention;

FIG. 2 is a schematic block diagram of a mobile terminal according to an example embodiment of the present invention;

FIGS. 3A, 3B, and 3C illustrate example user inputs that may be received by an apparatus that may embody, for example, the apparatus shown in FIG. 1, in accordance with an example embodiment of the present invention described herein;

FIG. 4 illustrates an example apparatus, such as the apparatus shown in FIG. 1, with a map being presented on a display, wherein a route extending from a starting point to a destination is presented on the map, in accordance with an example embodiment of the present invention described herein;

FIG. 5 illustrates the map shown in FIG. 4, wherein a location to avoid has been indicated, in accordance with an example embodiment of the present invention described herein;

FIG. 6 illustrates an example user input directed to the location on the map shown in FIG. 5, in accordance with an example embodiment of the present invention described herein;

FIG. 6A illustrates another example user input directed to the location on the map shown in FIG. 5, in accordance with an example embodiment of the present invention described herein;

FIG. 6B illustrates an example prompt presented on the map, such as may be presented in response to the user input shown in FIG. 6, in accordance with an example embodiment of the present invention described herein;

FIG. 7A illustrates an example modified route presented on the map shown in FIG. 6, in accordance with an example embodiment of the present invention described herein;

FIG. 7B illustrates another example modified route presented on the map shown in FIG. 6, in accordance with an example embodiment of the present invention described herein;

FIG. 8 illustrates another example user input directed to the location on the map shown in FIG. 5, in accordance with an example embodiment of the present invention described herein;

FIG. 8A illustrates an example prompt presented on the map, such as may be presented in response to the user input shown in FIG. 8, in accordance with an example embodiment of the present invention described herein;

FIG. 8B illustrates an example modified route presented on the map shown in FIG. 8, in accordance with an example embodiment of the present invention described herein;

FIG. 9 illustrates another example user input directed to the location on the map shown in FIG. 5, in accordance with an example embodiment of the present invention described herein;

FIG. 9A illustrates an example prompt presented on the map, such as may be presented in response to the user input shown in FIG. 9, in accordance with an example embodiment of the present invention described herein;

FIG. 9B illustrates an example modified route presented on the map shown in FIG. 8, in accordance with an example embodiment of the present invention described herein;

FIG. 10 illustrates another example user input directed to another location on the map shown in FIG. 5, in accordance with an example embodiment of the present invention described herein;

FIG. 10A illustrates another example user input directed to the starting location on the map shown in FIG. 5, in accordance with an example embodiment of the present invention described herein;

FIG. 10B illustrates an example modified route presented on the map shown in FIG. 10, in accordance with an example embodiment of the present invention described herein;

FIG. 10C illustrates an example prompt presented on the map, such as may be presented in response to the user input shown in FIG. 10A, in accordance with an example embodiment of the present invention described herein;

FIG. 11 illustrates a flowchart according to an example method for modification of routes based on user input, in accordance with an example embodiment of the present invention described herein;

FIG. 12 illustrates a flowchart according to an example method for modification of routes based on user input, in accordance with an example embodiment of the present invention described herein; and

FIG. 13 illustrates a flowchart according to another example method for modification of routes based on user input, in accordance with an example embodiment of the present invention described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

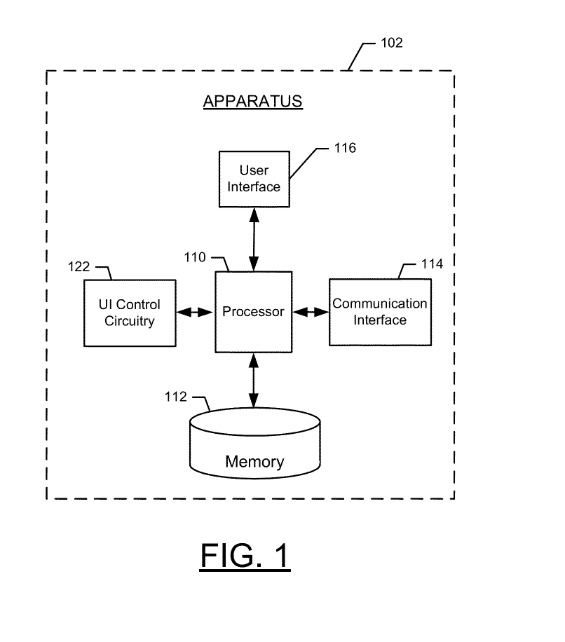

FIG. 1 illustrates a block diagram of an apparatus 102 configured for modification of routes based on user input according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for performing operations and operational routing, other configurations may also be used to implement embodiments of the present invention.

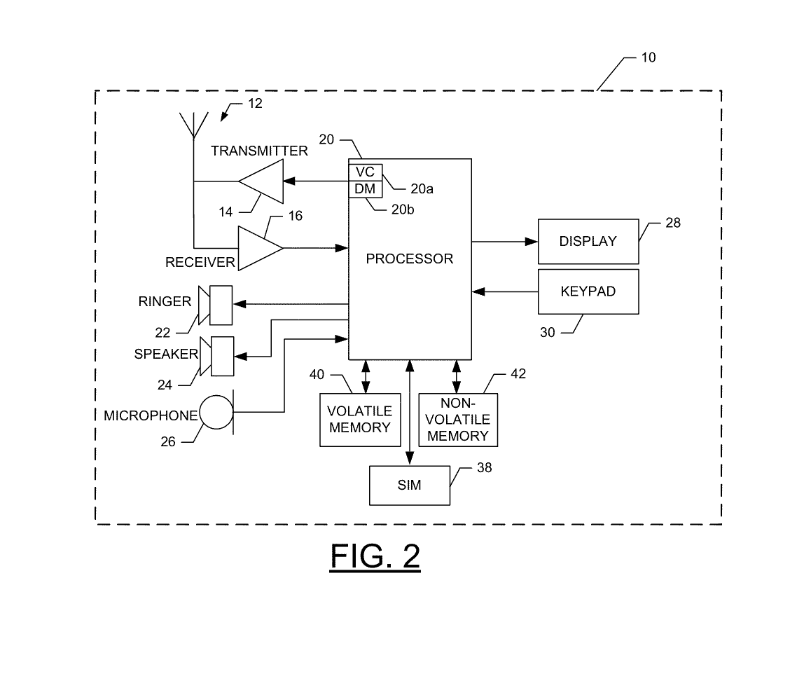

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a user interface (e.g., a touch display capable of displaying a graphical user interface). In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1 G), second generation (2 G), 2.5 G, third-generation (3 G) communication protocols, fourth-generation (4 G) communication protocols, Internet Protocol Multimedia Subsystem (IMS) communication protocols (e.g., session initiation protocol (SIP)), and/or the like. For example, the mobile terminal may be capable of operating in accordance with 2 G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5 G wireless communication protocols General Packet Radio Service (GPRS), Enhanced Data GSM Environment (EDGE), and/or the like. Further, for example, the mobile terminal may be capable of operating in accordance with 3 G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9 G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4 G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of communicating according to Wi-Fi, Near Field Communications (NFC), BlueTooth, Worldwide Interoperability for Microwave Access (WiMAX) or other proximity-based communications protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the interne or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. Additionally or alternatively, the communication interface 114 may be configured to support communications in accordance with any proximity-based protocol including, for example, Wi-Fi, NFC, BlueTooth, WiMAX or the like. The communication interface 114 may additionally be in communication with the memory 112, user interface 116, and/or UI control circuitry 122, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touchscreen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

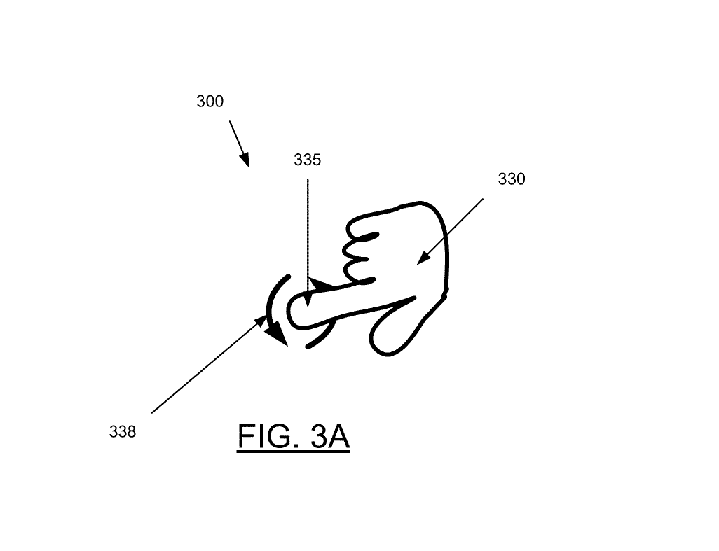

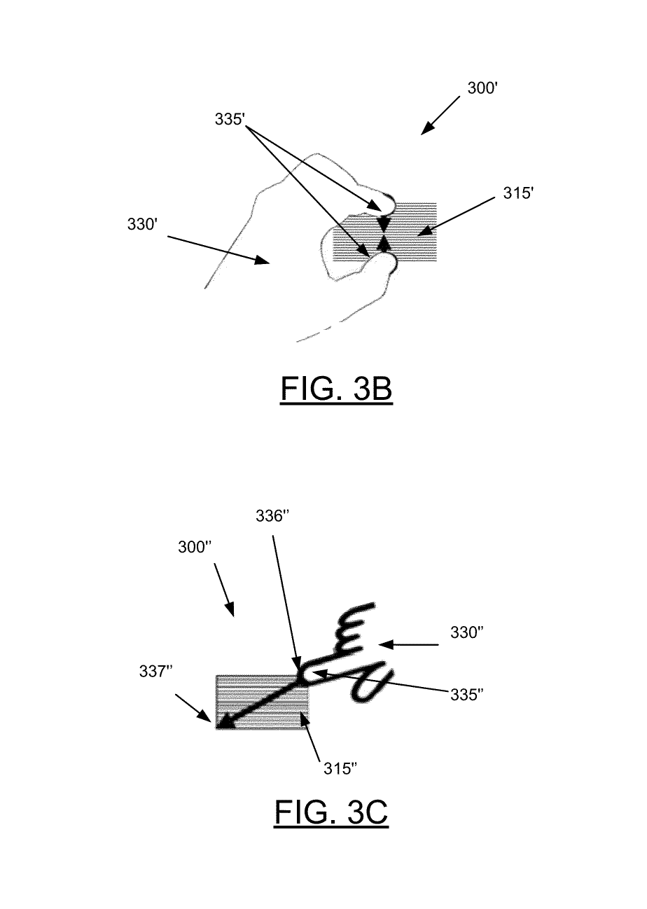

The apparatus 102 may be configured to receive input on a display (e.g., user interface 116). In some embodiments, such as in an instance when the user interface 116 comprises a touch display, the user input may be in the form of a gesture on or near the display. Some examples of gestures are shown in FIGS. 3A, 3B, and 3C. Though some example embodiments may be described as a single user input or gesture, such user inputs may comprise a first user input and a second user input, such as from the perspective of the apparatus 102 shown in FIG. 1.

FIG. 3A illustrates an example user input 300 for a touch screen display (e.g., user interface 116 shown in FIG. 1). In the depicted embodiment, a user 330 positions their finger 335 on the display to indicate a location. Additionally, the user 330 twists (e.g., rotates) their finger (e.g., along arrow 338). Such an input may be referred to as a “point and twist” gesture. In some embodiments, the “point and twist” gesture may comprise a first user input that includes the pointing of the user's finger to a location on the display and a second user input that includes the twisting of the user's finger. In some embodiments, a user may position a finger and thumb at a location and perform the “point and twist” gesture (e.g., similar to twisting a door knob).

FIG. 3B illustrates an example user input 300′ for a touch screen display 315′ (e.g., user interface 116 shown in FIG. 1). In the depicted embodiment, a user 330′ positions their fingers 335′ on or near a portion of the display. The user's pointer finger defines the upper limitation of the input and the user's thumb defines the lower limitation of the input. In the depicted embodiment, the user 330′ may bring their fingers 335′ together (e.g., in a pinching motion). Such an input may be referred to as a “pinch” gesture. In some embodiments, the “pinch” gesture may comprise a first user input that includes the indication of a location on the display (e.g., the location approximately positioned centrally between the fingers of the user) and a second user input that includes the bringing of the user's fingers together.

In some embodiments, the user 330′ may start with their fingers 335′ together and may spread their fingers 335′ apart. Such an input may be referred to as a “reverse pinch” gesture. In some embodiments, the “reverse pinch” gesture may comprise a first user input that includes the indication of a location on the display (e.g., the location the user's fingers start together) and a second user input that includes the spreading apart of the user's fingers.

FIG. 3C illustrates yet another example user input 300″ for a touch screen display 315″ (e.g., user interface 116 shown in FIG. 1). In the depicted embodiment, a user 330″ positions a finger 335″ on or near a portion of the display. The user's finger may define a start position 336″. Then, the user 330″ may slide their finger 335″ toward another position on the display (e.g., an end position 337″). Such an input may be referred to as a “slide” gesture. In some embodiments, the “slide” gesture may comprise a first user input that includes the indication of a location on the display and a second user input that includes the movement of the user's fingers away from the location.

As noted above, the apparatus 102 (shown in FIG. 1) may be configured to perform operations. Indeed, in some embodiments, the apparatus 102 may be configured to function as a navigation system that provides geographical and/or travel information for a user, such as provide directions to the user. In some embodiments, the apparatus 102 may be configured to cause calculation of a route in a map. For example, the user may input a starting location and/or a destination. Then, based on available map data (e.g., from a server or local database), the apparatus 102 may be configured to calculate a route between the starting location and the destination.

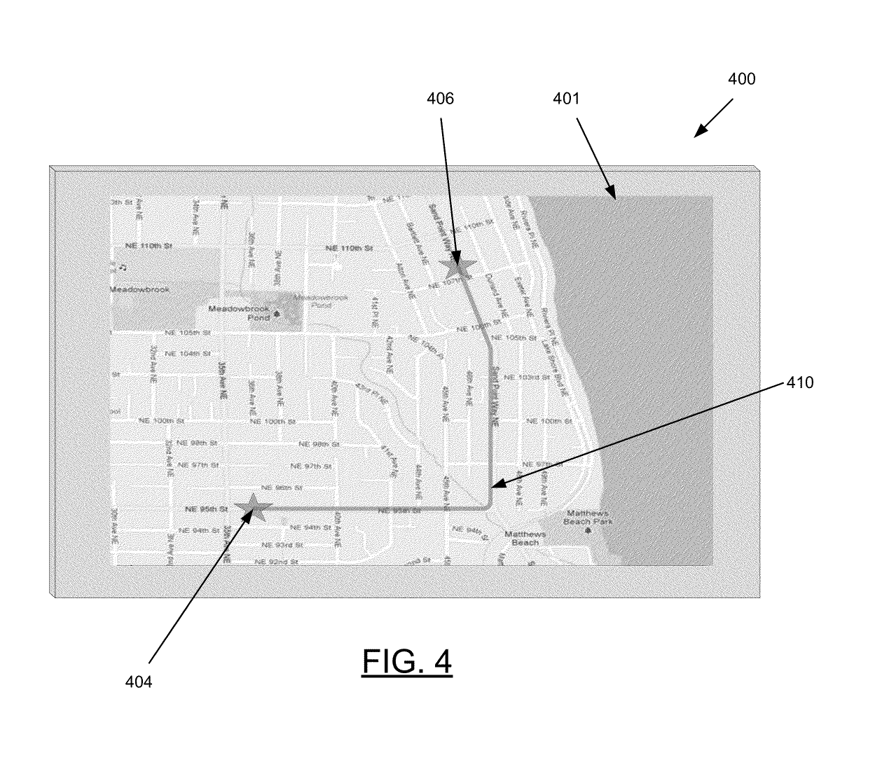

In some embodiments, the apparatus 102 (shown in FIG. 1) may be configured to cause presentation of the map, such as on user interface 116. Moreover, in some embodiments, the apparatus 102 may be configured to cause presentation of the calculated route on the map. For example, with reference to FIG. 4, an apparatus 400 may present a portion of a map on a display 401. The apparatus 400 may also present a route 410 on the map. In the depicted embodiment, the route 410 extends from a starting location 404 to a destination 406.

Considering the usefulness of the above noted navigation features and the ability of users to carry mobile computing devices (e.g., apparatus 102 shown in FIG. 1), users may now rely on their mobile computing devices to get where they need to go. However, often while following the route, a detour might be needed or otherwise desired. For example, a traffic jam may be present, an accident may have occurred, a road may be unexpectedly closed, a waypoint may be desired, a gas-stop may be needed, or any number of reasons may exist why a user may want to take a detour from the previous route.

As such, example embodiments of the present invention seek to provide for detour calculation for a route based on a simple and easy user input. Indeed, in some embodiments, such a user input may be performed on the go, potentially with one hand, or even one finger.

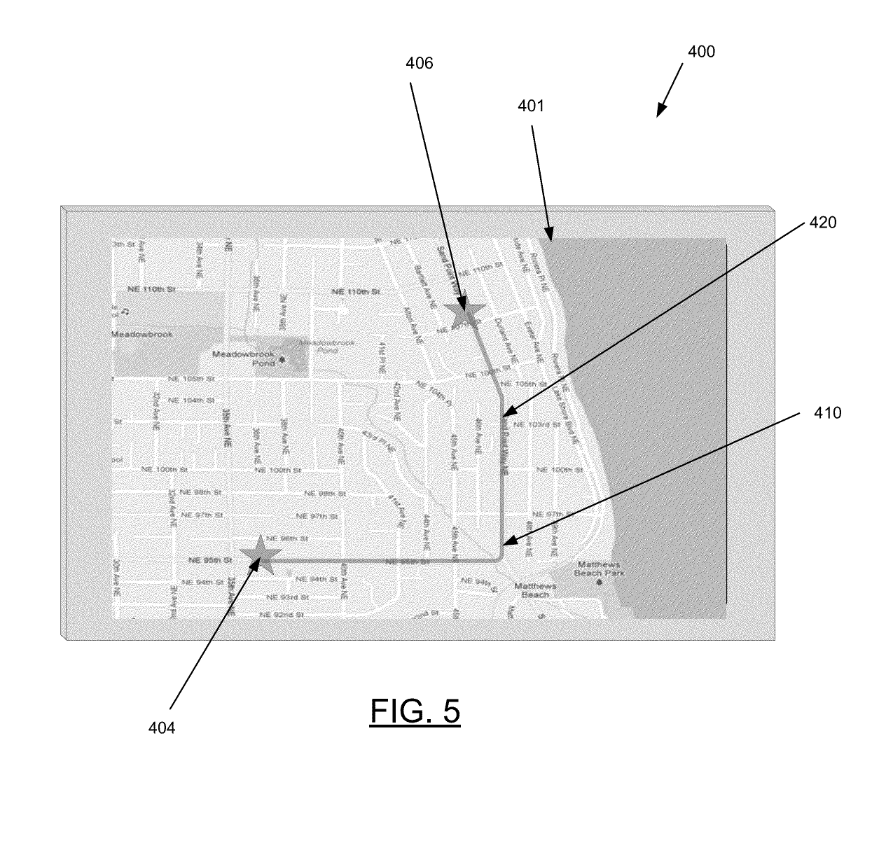

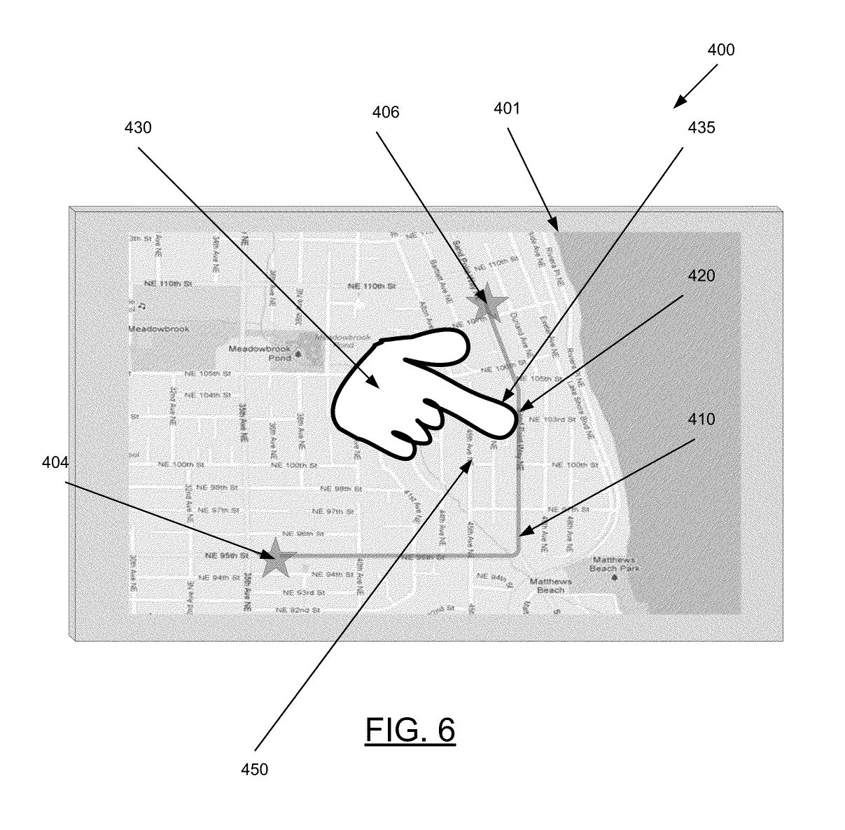

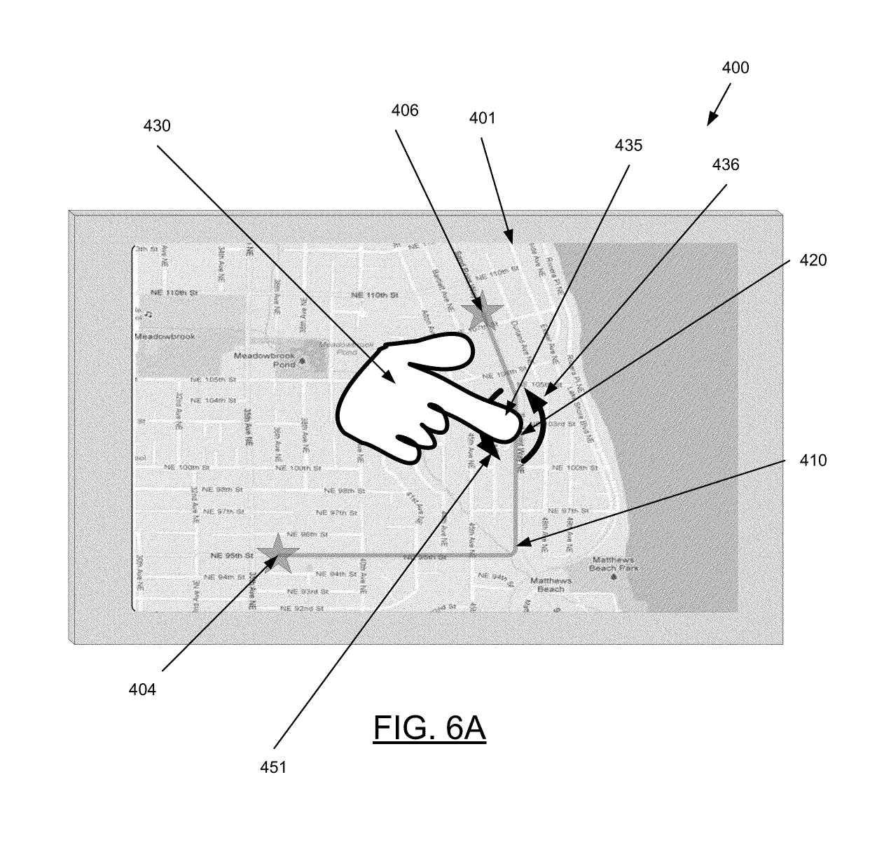

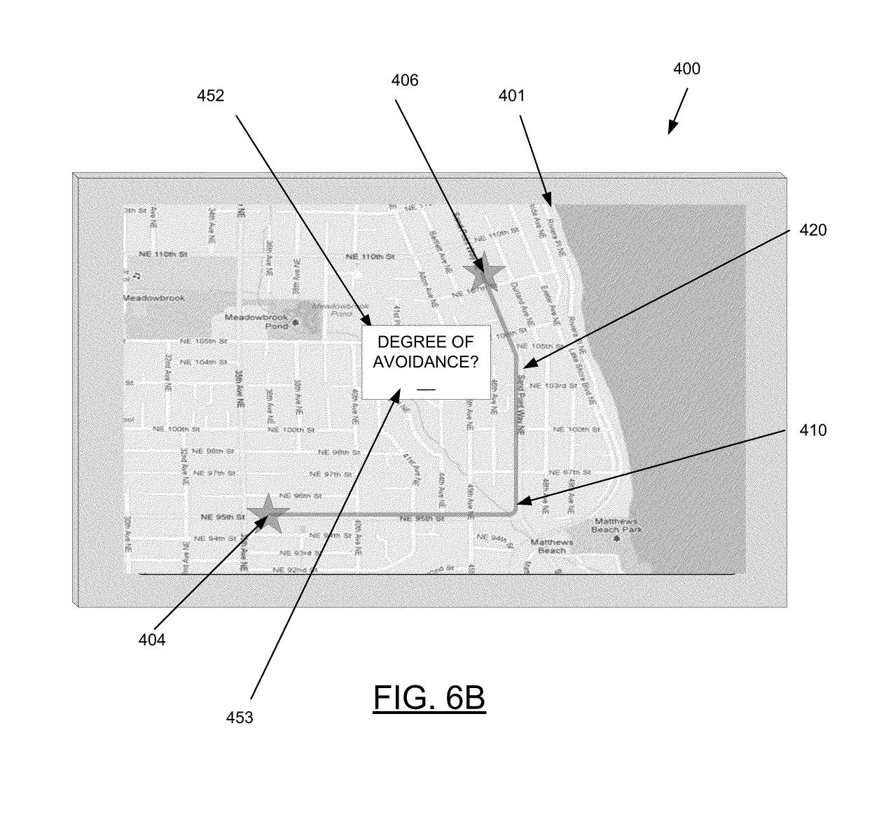

In such a regard, in some embodiments, the apparatus 102 (shown in FIG. 1) may be configured to receive input indicating a location along a route that the user desires to avoid. For example, with reference to FIG. 5, a user may desire to avoid location 420 along the route 410. Thus, with reference to FIG. 6, the user 430 may provide input 450 to the location 420. In the depicted embodiment, the user 430 points their finger 435 to the location 420 on the route 410 thereby indicating the location along the route the user desires to avoid.

Additionally, in some embodiments, the apparatus 102 (shown in FIG. 1) may be configured to receive input indicating a user preference associated with avoidance of the location. In some embodiments, the input may indicate both the location along the route and the user preference associated with avoidance of the location. The input received by the apparatus 102 may be any input that indicates the location and the user preference (e.g., a single input, a double tap, a “point and twist” gesture, a “slide” gesture, a “pinch” gesture, a “reverse pinch” gesture, etc.). Additionally, as indicated above, the apparatus 102 may be configured to receive input indicating the location along the route and the user preference associated with avoidance of the location by receiving a first input indicating the location along the route and receiving a second input indicating the user preference associated with avoidance of the location. Indeed, some of the examples of user input described herein may be defined as a first input and a second input.

In some embodiments, the apparatus 102 may be configured to receive input indicating a user preference that includes a desired degree of avoidance of the location. For example, a user may have a preference regarding how far away from the location they would like the detour to take them. In some cases, the distance a user desires to travel around a location to avoid it may depend on the reason for the desired detour around the location. For example, a nearby music concert may cause a significant amount of traffic that may affect a radius that spans a few blocks. In such a situation a detour to the next street over would likely be insufficient for avoidance of the location. In such a situation, the user may wish to indicate a greater degree of avoidance of the location. Along these same lines, a minor accident may require only a small degree of avoidance of the location.

Thus, in some embodiments, a user may perform an input that indicates the location and indicates a desired degree of avoidance of the location. An example user input is illustrated in FIG. 6A with a “point and twist” gesture 451. In the depicted embodiment, the user 430 points their finger 435 at the location 420 to avoid along the route 410. Then, the user 430 twists (e.g., rotates along arrow 436). In some embodiments, the degree of twist of the user input indicates the desired degree of avoidance. For example, the user may only twist their finger a little (e.g., 45 degrees) to indicate a desired small degree of avoidance of the location. Along these lines, the user may twist their finger a moderate amount (e.g., 90 degrees) to indicate a desired moderate degree of avoidance of the location. Likewise, the user may twist their finger a large amount (e.g., 180 degrees) to indicate a desired large degree of avoidance of the location.

In some embodiments, the apparatus 102 (shown in FIG. 1) may be configured to receive other input to indicate the location and the desired degree of avoidance of the location. For example, the input may be a “reverse pinch” gesture. In such an embodiment, the distance of travel of the user's fingers during their spreading apart may correlate to the desired degree of avoidance of the location. In some embodiments, the input may be a “slide” gesture. In such an embodiment, the distance of travel of the user's finger along the display may correlate to the desired degree of avoidance of the location. Likewise, as indicated above, other types of input are contemplated (e.g., a “pinch” gesture, a double tap, etc.).

As noted above, in some embodiments, the apparatus 102 may be configured to receive a first input indicating the location along the route and receive a second input indicating the user preference associated with avoidance of the location. In some embodiments, the apparatus 102 may be configured to prompt the user to indicate a desired degree of avoidance in response to receiving the first input indicating a location along the route. The indication of the degree of avoidance may comprise any value or qualifier (e.g., high, low, number, degree, percentage, etc.). For example, in response to the input 450 illustrated in FIG. 6, the apparatus 400, with reference to FIG. 6B, may present a prompt 452 that instructs the user to enter a desired degree of avoidance of the location indicated, such as with the message “DEGREE OF AVOIDANCE?” 453. Then, in response, the user may provide a second input that indicates the desired degree of avoidance (e.g., the user may enter a qualifier such as “low”).

Though the above example includes a detailed input of the degree of avoidance desired by the user, other methods of input are contemplated (e.g., the user may select from a list of available detours). For example, in some embodiments, in response to receiving input directed to the location, the apparatus 102 (shown in FIG. 1) may be configured to cause display of a list of available modified routes for a user to select from.

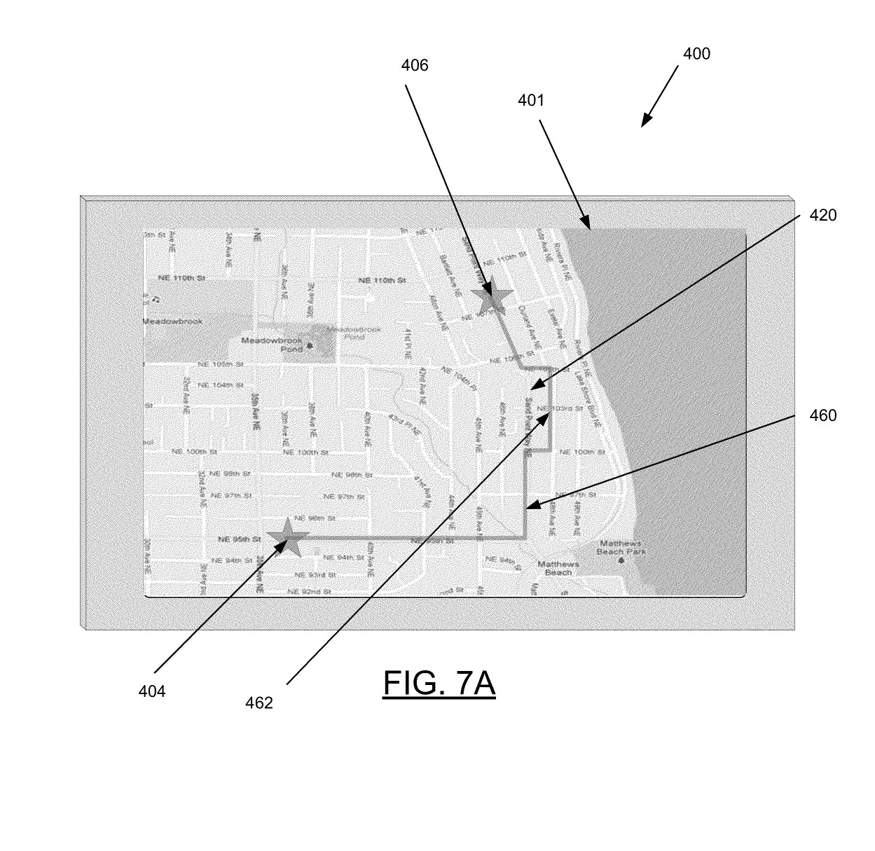

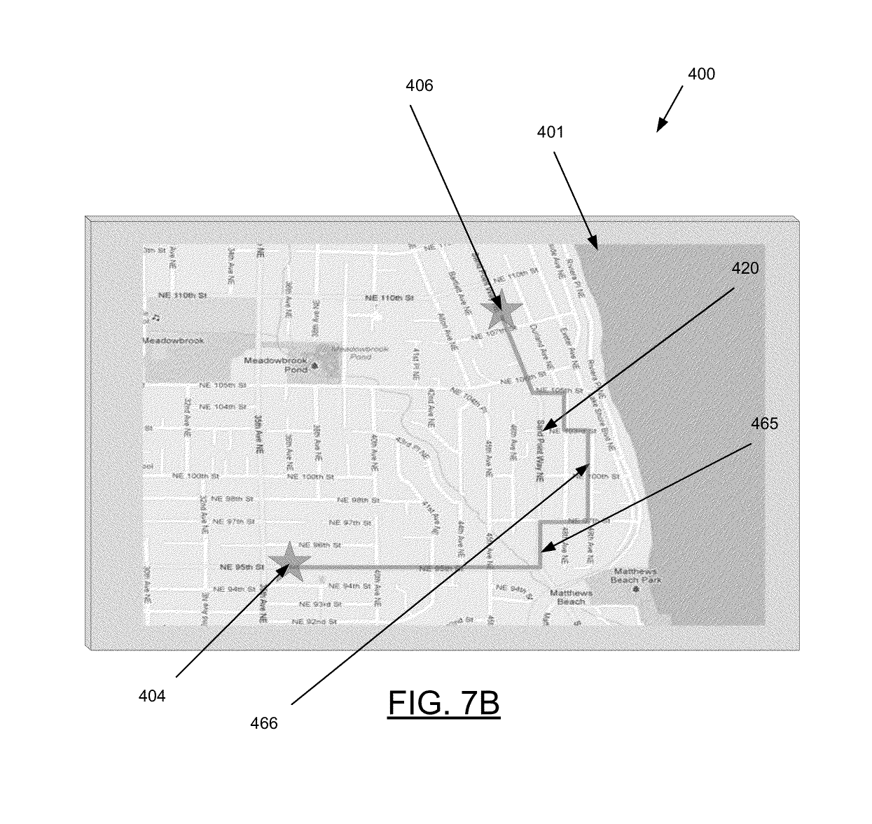

In some embodiments, the apparatus 102 (shown in FIG. 1) may be configured to determine, based at least in part on the input, a modification to the route. In such a regard, in some embodiments, the modification to the route may take into account the indicated location and the user preference associated with avoidance of the location. For example, the apparatus 102 may be configured to modify the route to avoid the location (e.g., create a detour). Additionally, in some embodiments, the apparatus 102 may be configured to cause presentation of the route on the map to be modified based on the determined modification to the route. For example, in response to receiving input 450 (shown in FIG. 6), the apparatus 400, may determine a modification to the route that avoids the indicated location 420. Additionally, with reference to FIG. 7A, the apparatus 400 may present the modified route 460 on the map that is presented on the display 401. In the depicted embodiment, the apparatus 400 has determined modification of the route to include a slight detour for a couple blocks along an adjacent street 462.

In some embodiments, the apparatus 102 (shown in FIG. 1) may be configured to determine, based at least in part on the input, a modification to a portion of the route within a proximity of the location to be avoided. For example, the apparatus 102 may be configured to modify only a portion of the route, as opposed to the entire route. Additionally, in some embodiments, the apparatus 102 may be configured to modify a portion of the route within a proximity of the location, such a proximity being indicated by the user preference associated with avoidance of the location. For example, as will be described in greater detail herein, the user may provide a user preference that includes an indication of a desired degree of avoidance. In such a situation, the apparatus 102 may be configured to determine the proximity of which to start the detour based on the desired degree of avoidance. In some of such example embodiments, a portion of the original route remains as previously determined, as the user may wish to remain as true to the original route as possible.

In some embodiments, the apparatus 102 may be configured to determine the modification to the route based at least in part on the user preference associated with avoidance of the location. In some embodiments, the apparatus 102 may be configured to determine the modification to the route based at least in part on the desired degree of avoidance of the location. For example, in response to receiving input with an indication of a desired degree of avoidance of the location, the apparatus 102 may be configured to determine a modification to the route that correlates with the desired degree of avoidance. For example, in response to receiving an indication of a desired small degree of avoidance, the apparatus 102 may be configured to determine a modified route that causes the user to only slightly detour around the location. For example, with reference to FIG. 7A, the modified route 460 includes a slight detour to an adjacent street 462.

In contrast, in some embodiments, if a user indicates a desired larger degree of avoidance, the apparatus 102 (shown in FIG. 1) may be configured to determine a modified route that causes the route to undergo a greater detour around the location. For example, with reference to FIG. 7B, the modified route 465 includes a detour to a street 466 that is two streets away from the indicated location 420 to avoid.

While the above described examples provide for a variation in the degree of avoidance based on how far removed the street of the detour is away from the indicated location to avoid, other factors may be considered and implemented for determining a modification to the route that includes a greater degree of avoidance (e.g., the distance away from the location where the detour begins, the overall distance of travel of the detour, among others).

In some embodiments, the apparatus 102 (shown in FIG. 1) may be configured to receive input indicating a user preference that includes a desired point of interest to pass by. A point of interest may be any location, landmark, service, or other feature the user may wish the detour to pass by. For example, the user may want to stop at a gas station or a convenience store.

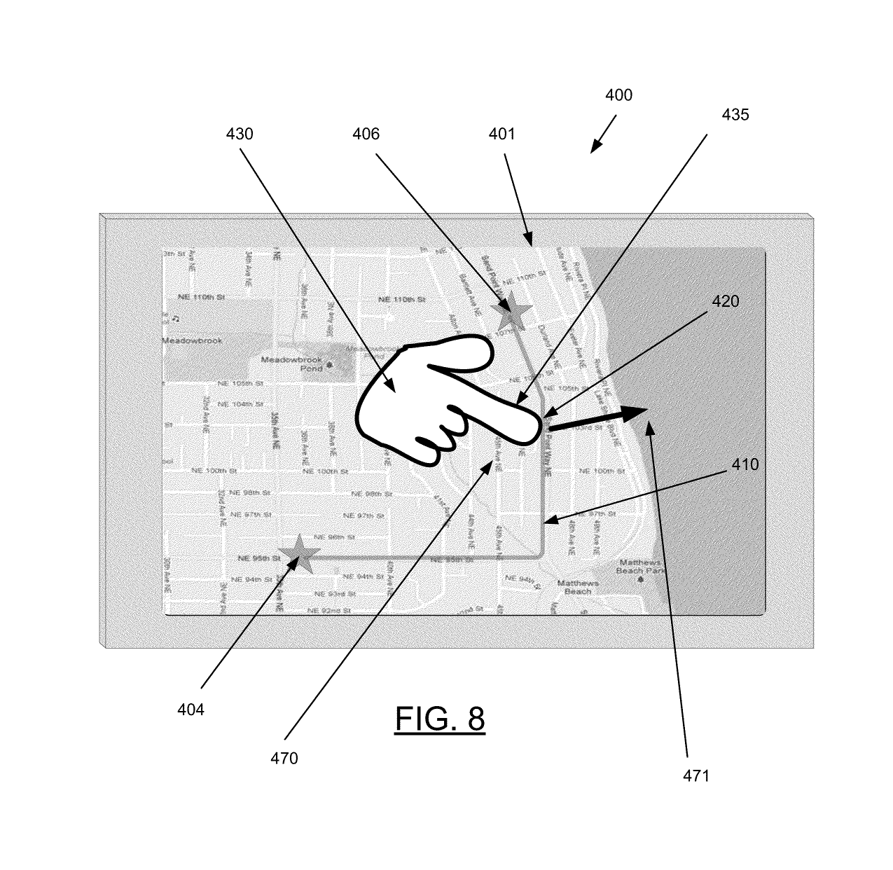

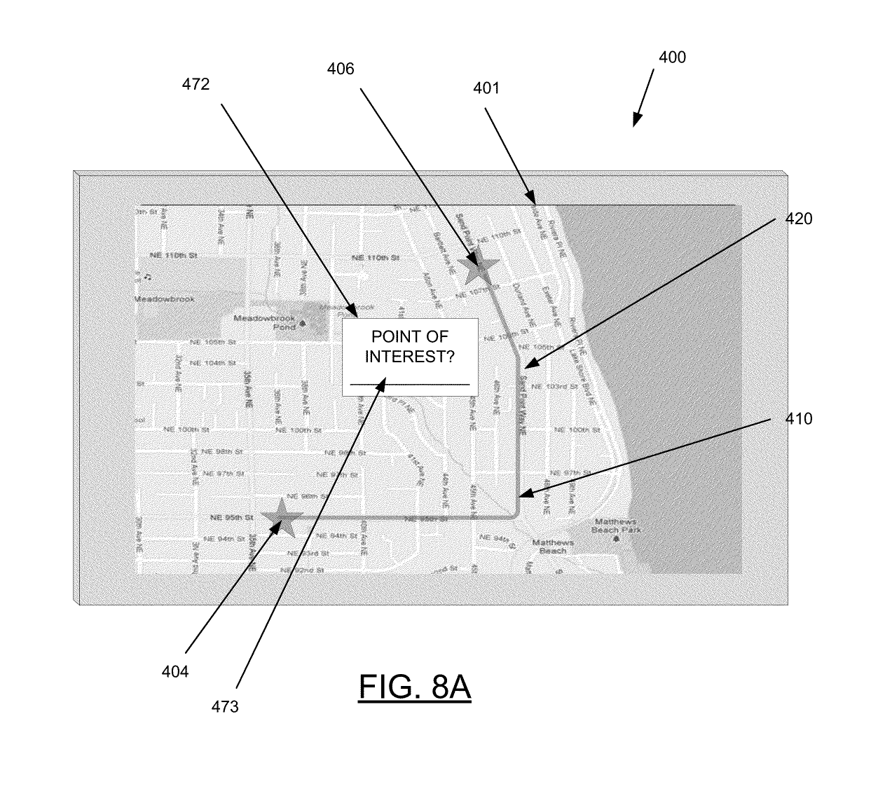

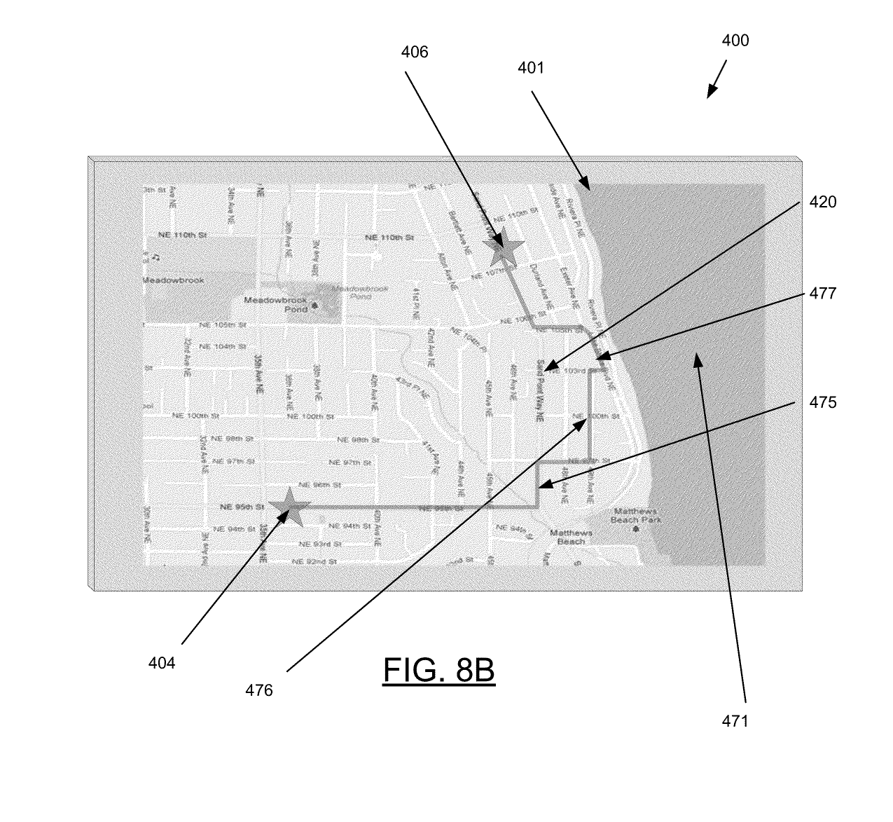

FIG. 8 illustrates an example user input that indicates a point of interest to pass by. In the depicted embodiment, a user 430 positions their finger 435 to indicate the location 420 along the route. Then, the user 430 slides their finger 435 toward the lake 471 indicating that they wish to pass by the lake 471. In such a manner, the user 430 performs a “slide” gesture 470.

In some embodiments, the apparatus 102 (shown in FIG. 1) may be configured to receive other input to indicate the location and the desired point of interest to pass by (e.g., multiple subsequent taps, a “pinch” gesture, etc.).

As noted above, in some embodiments, the apparatus 102 may be configured to receive a first input indicating the location along the route and receive a second input indicating the user preference associated with avoidance of the location. In some embodiments, the apparatus 102 may be configured to prompt the user to indicate the desired point of interest to pass by in response to receiving the first input indicating a location along the route. In some embodiments, the indication of the desired point of interest may include direct input from a user detailing the point of interest. For example, in response to the input 450 illustrated in FIG. 6, the apparatus 400, with reference to FIG. 8A, may present a prompt 472 that instructs the user to enter a desired point of interest to pass by, such as with the message “POINT OF INTEREST?” 473. Then, in response, the user may provide a second input that indicates the desired point of interest (e.g., the lake). Though the above example includes a detailed input of the point of interest by the user, other methods of input are contemplated (e.g., the user may select from a list of available points of interest).

In some embodiments, the apparatus 102 (shown in FIG. 1) may be configured to determine the modification to the route based at least in part on the desired point of interest to pass by. For example, in response to receiving input with an indication of a desired point of interest to pass by, the apparatus 102 may be configured to determine a modification to the route that passes by the desired point of interest. For example, with reference to FIG. 8B, in response to receiving an indication of a desired point of interest of the lake (e.g., input 470 shown in FIG. 8), the apparatus 400 may determine a modified route that brings the user by the lake 471. For example, in the depicted embodiment, the modified route 475 includes a detour 476 that includes a street 477 that passes by the lake 471.

In some embodiments, the apparatus 102 (shown in FIG. 1) may be configured to receive input indicating a user preference that includes a desire to travel on a road that includes less traffic. Such an embodiment may enable a user to provide input to the apparatus to modify the route based on the flow of traffic and, thus, the route may not be limited to the shortest distance between the starting location and the destination. For example, the user may not mind traveling a further distance if it means dealing with less traffic.

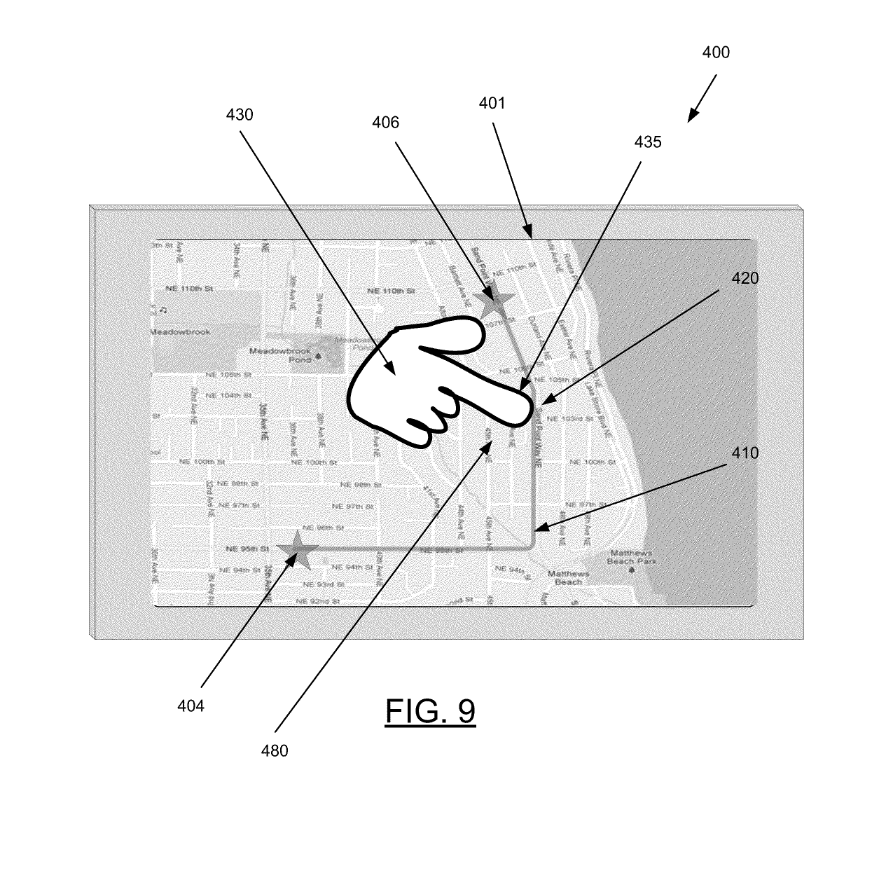

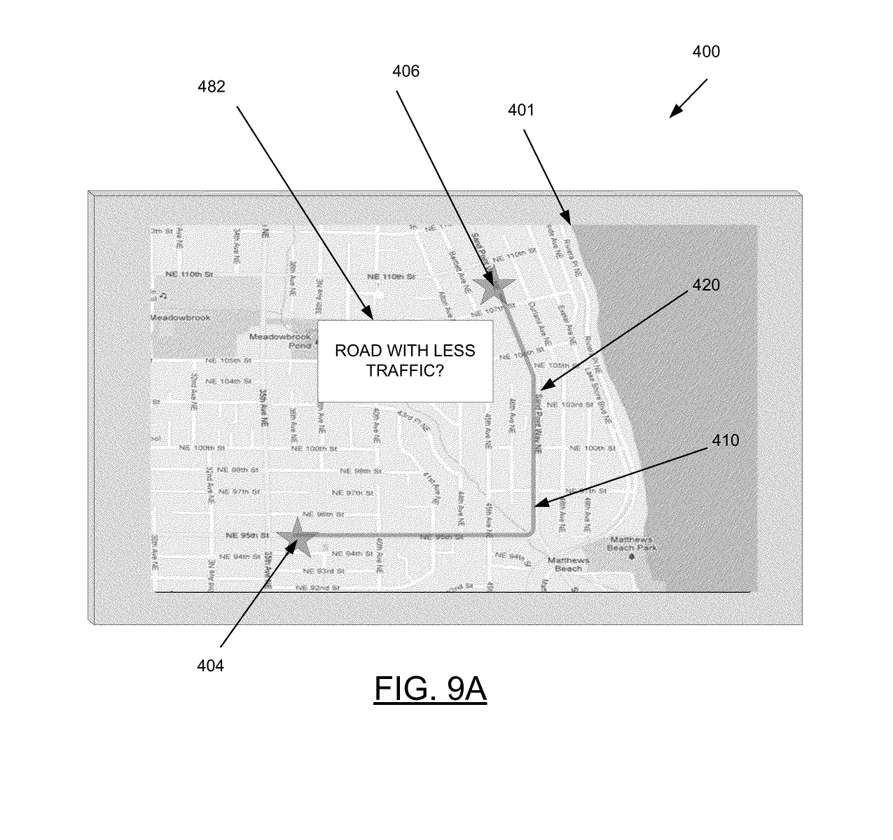

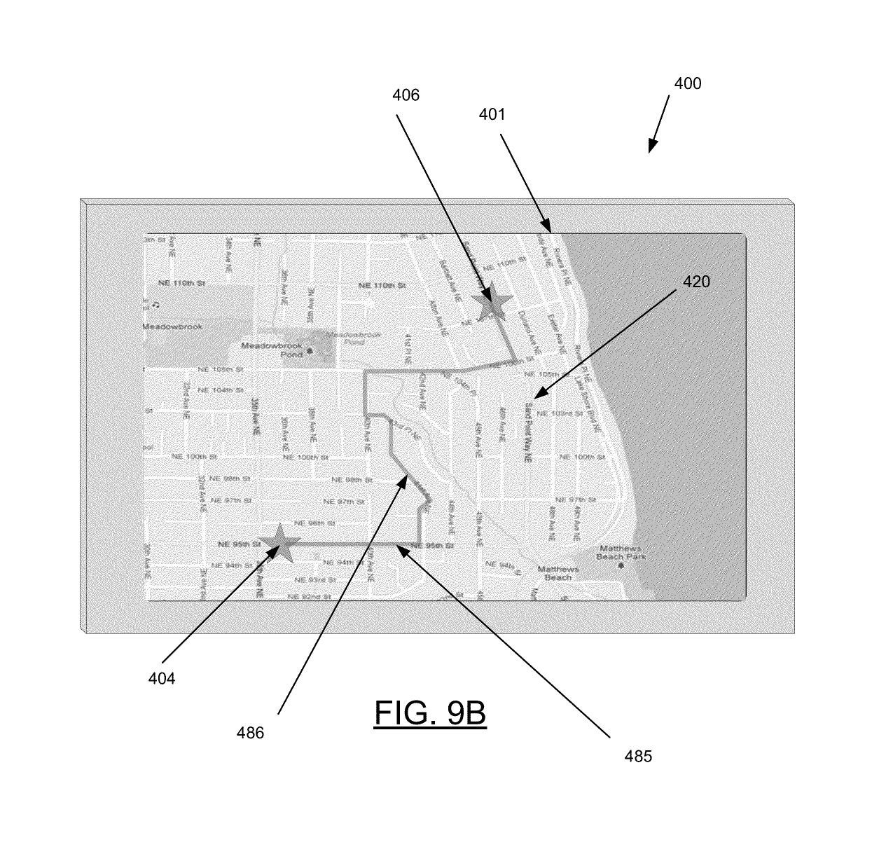

FIG. 9 illustrates an example user input that indicates a desire to travel on a road that includes less traffic. In the depicted embodiment, a user 430 positions their finger 435 to indicate the location 420 along the route. In such a manner, the user 430 performs a “tap” gesture 480. In some embodiments, the apparatus 102 (shown in FIG. 1) may be configured to receive other input to indicate the location and the desire to travel on a road that includes less traffic (e.g., a double tap, a “pinch” gesture, etc.).

As noted above, in some embodiments, the apparatus 102 may be configured to receive a first input indicating the location along the route and receive a second input indicating the user preference associated with avoidance of the location. In some embodiments, the apparatus 102 may be configured to prompt the user to indicate whether they have a desire to travel on a road that includes less traffic in response to receiving the first input indicating a location along the route. For example, in response to the input 480 illustrated in FIG. 9, the apparatus 400, with reference to FIG. 9A, may present a prompt 482 that instructs the user to indicate whether they want to travel on a road with less traffic, such as with the message “ROAD WITH LESS TRAFFIC?” 473. Then, in response, the user may provide input that indicates that the do have a desire to travel on a road with less traffic. Though the above example includes a detailed input of whether a user wants to travel on roads with less traffic, other methods of input are contemplated (e.g., the user may select from a list of available detours).

In some embodiments, the apparatus 102 (shown in FIG. 1) may be configured to determine the modification to the route based at least in part on the desire to travel on a road that includes less traffic. For example, in response to receiving input with an indication of a desire to travel on a road that includes less traffic, the apparatus 102 may be configured to determine a modification to the route that includes travel on roads with less traffic. For example, with reference to FIG. 9B, in response to receiving an indication to travel on roads with less traffic (e.g., input 480 shown in FIG. 9), the apparatus 400 may determine a modified route that takes the user on a road with less traffic (e.g., side streets or residential streets). For example, in the depicted embodiment, the modified route 485 includes a detour 486 along different streets with less traffic.

Though some example embodiments described herein detail specific examples of user preferences associated with avoidance of a location (e.g., a desired degree of avoidance of the location, a desired point of interest to pass by, or a desire to travel on roads with less traffic), other user preferences are contemplated (e.g., a desire to not take toll roads, etc.). Additionally, though the above described embodiments detail separate user preferences, some embodiments of the present invention contemplate any combination of user preferences for modification of a route.

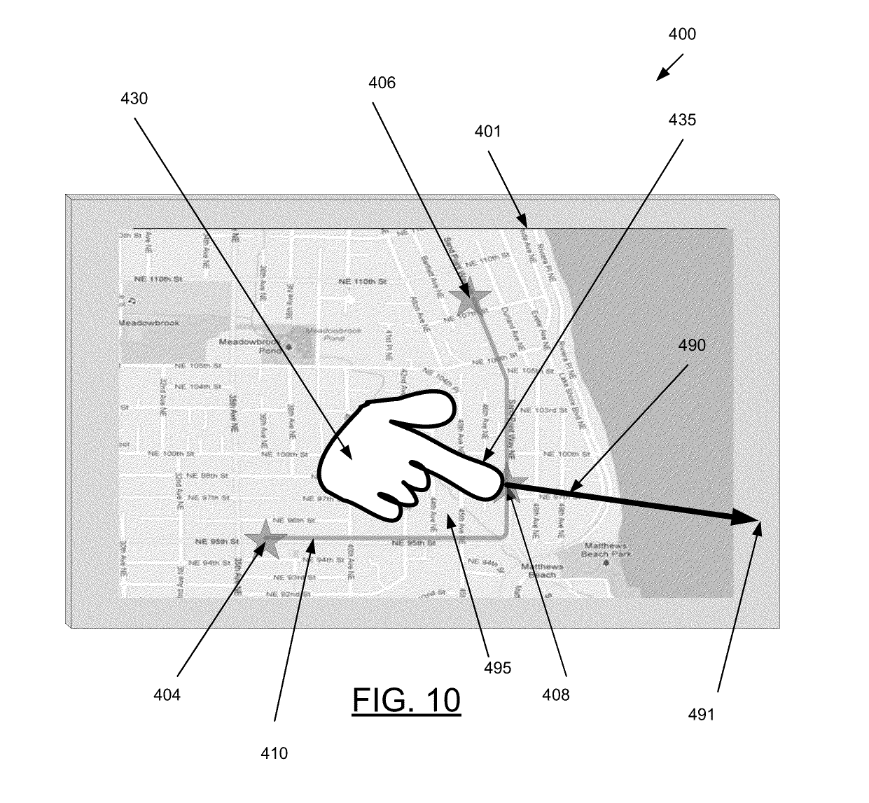

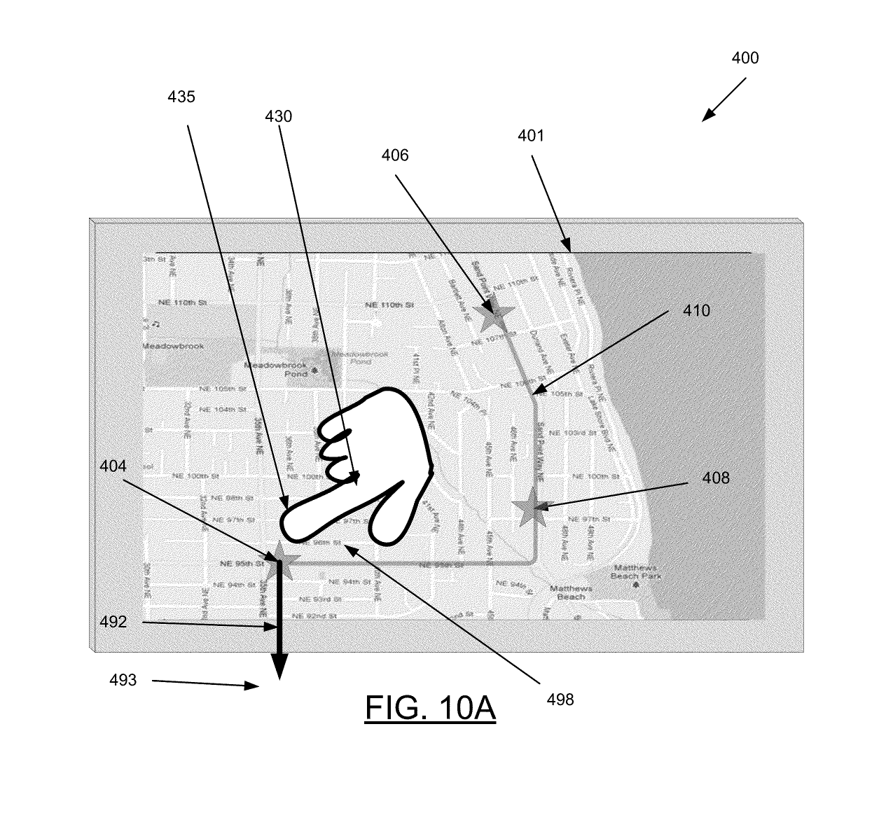

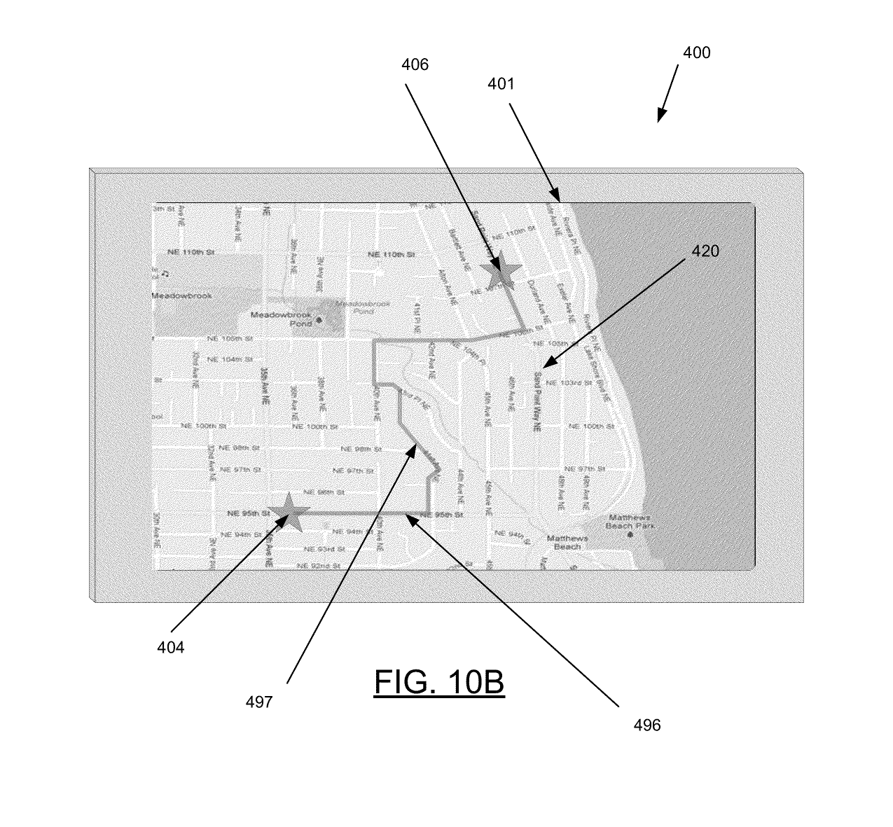

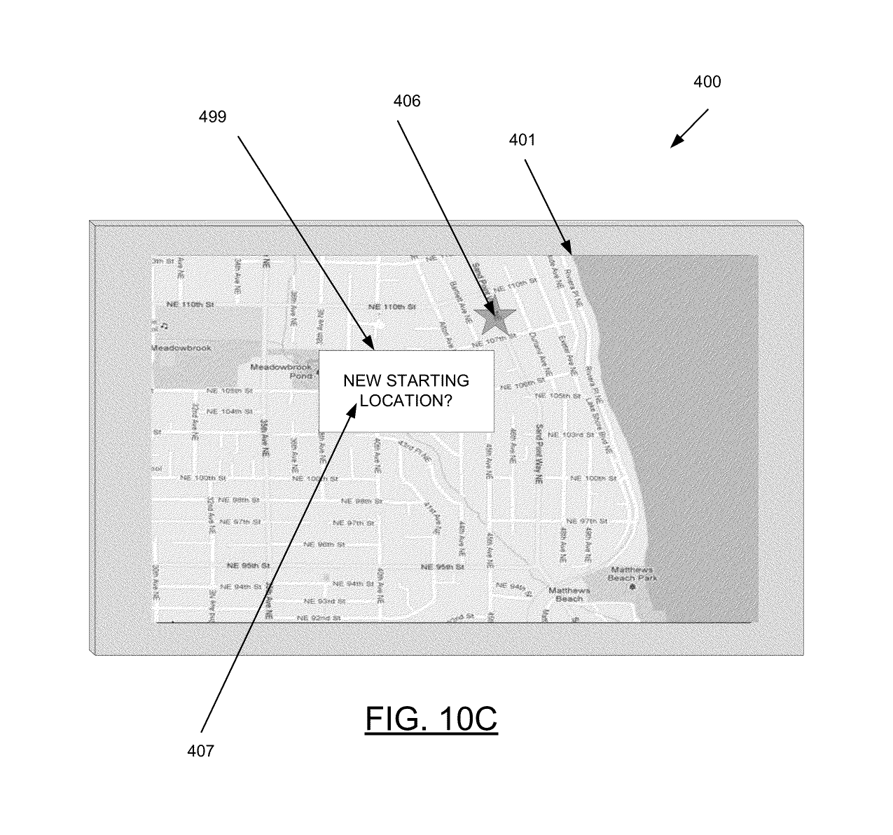

In some embodiments, the apparatus 102 may be configured to receive input indicating a change to a location along the route. For example, a user may provide input to a location along the route that indicates that the user wishes to change and/or remove that location from the route. Such an input may be easy to perform and may allow for an easy and quick way for a user to update a route. In some embodiments, the input may comprise indication first input that indicates the location along the route and second input that indicates a user's desire to change and/or remove the location. In some embodiments, the input may include a “slide” gesture that starts with the location and ends off the display of the apparatus. For example, FIG. 10 illustrates an example user input 495 directed to a waypoint 408 along the route 410. The user 430 may position a finger 435 proximate the waypoint 408. Then, the user 430 may slide their finger 435 (e.g., along arrow 490) off the display 401 of the apparatus 400 (e.g., indicated by 491).

While the above described embodiment details changing or removing waypoints along the route, other locations are contemplated by some embodiments of the present invention. For example, the apparatus 102 (shown in FIG. 1) may be configured to receive input indicating a user's desire to change and/or remove the starting location and/or the destination of the route. For example, FIG. 10A illustrates an example user input 498 directed to the starting location 404 of the route 410. The user 430 may position a finger 435 proximate the starting location 404. Then, the user 430 may slide their finger 435 (e.g., along arrow 492) off the display 401 of the apparatus 400 (e.g., indicated by 493).

In some embodiments, the apparatus 102 (shown in FIG. 1) may be configured to receive other input to indicate the location and a desire to change and/or remove the location (e.g., multiple subsequent taps, a “reverse pinch” gesture, etc.).

As used herein, some embodiments of the present invention may receive input indicating a user's desire to remove a location, while other embodiments may receive input indicating a user's desire to change a location. Indeed, in some embodiments, this distinction may be predefined for the apparatus 102, or in some cases, it may be configured such as by the user.

In some embodiments, in response to receiving input indicating a user's desire to remove a location along the route, the apparatus 102 may be configured to determine a modification to the route. For example, with reference to FIG. 10B, in response to receiving an indication to remove the waypoint 408 (e.g., input 495 shown in FIG. 10), the apparatus 400 may determine a modified route without the waypoint 408. For example, in the depicted embodiment, the modified route 496 includes travel on a different street 497.

In some embodiments, in response to receiving input indicating a user's desire to change a location along the route, the apparatus 102 (shown in FIG. 1) may be configured to prompt a user to enter a new location. For example, in response to the input 498 illustrated in FIG. 10A, the apparatus 400, with reference to FIG. 10C, may present a prompt 499 that instructs the user to enter a new starting location, such as with the message “NEW STARTING LOCATION?” 407. Then, in response, the user may provide a second input that indicates the new starting location. Then, in some embodiments, in response to receiving the new location, the apparatus 102 (shown in FIG. 1) may be configured to calculate a new route from the new starting location to the destination.

Along these same lines, in some embodiments, the apparatus 102 may be configured to receive input indicating a location that the user would like to add to the route. In such a regard, the apparatus 102 may be configured to modify the route to include the location (e.g., set a waypoint).

As such, the above described example embodiments provide for dynamic and simple modification to routes. Such example embodiments allow a user to easily modify their routes with simple user input.

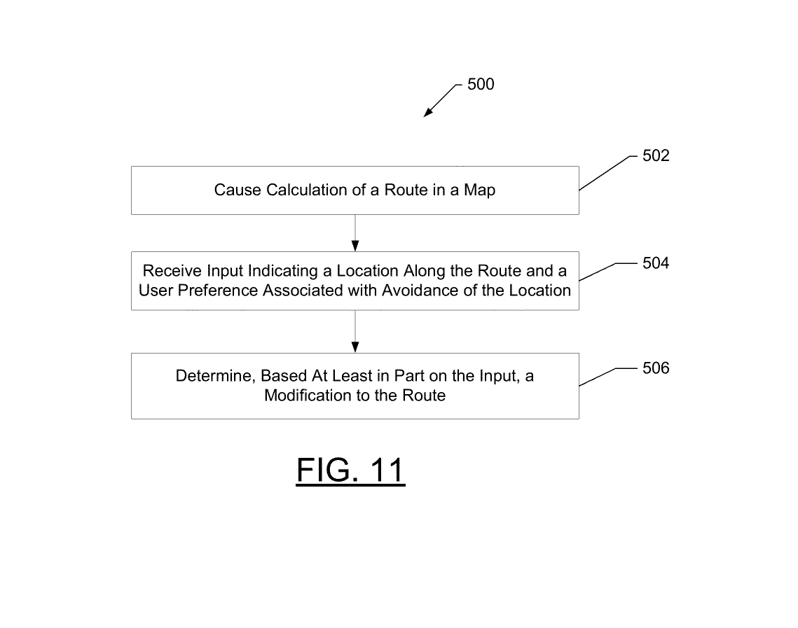

Embodiments of the present invention provide methods, apparatus and computer program products for modification of routes based on user input. Various examples of the operations performed in accordance with embodiments of the present invention will now be provided with reference to FIGS. 11-13.

FIG. 11 illustrates a flowchart according to an example method for modification of routes based on user input according to an example embodiment 500. The operations illustrated in and described with respect to FIG. 11 may, for example, be performed by, with the assistance of, and/or under the control of one or more of the processor 110, memory 112, communication interface 114, user interface 116, or UI control circuitry 122 (shown in FIG. 1). Operation 502 may comprise causing calculation of a route in a map. The processor 110 may, for example, provide means for performing operation 502. Operation 504 may comprise receiving input indicating a location along the route and a user preference associated with avoidance of the location. The processor 110, user interface 116, and/or UI control circuitry 122 may, for example, provide means for performing operation 504. Operation 506 may comprise determining, based at least in part on the input, a modification to the route. The processor 110 may, for example, provide means for performing operation 506.

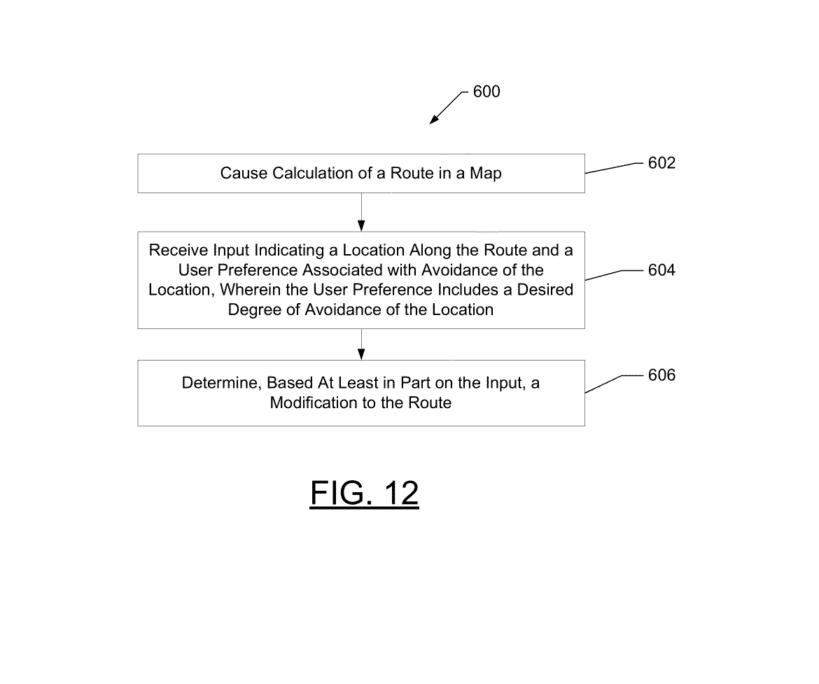

FIG. 12 illustrates a flowchart according to another example method for modification of routes based on user input according to an example embodiment 600. The operations illustrated in and described with respect to FIG. 12 may, for example, be performed by, with the assistance of, and/or under the control of one or more of the processor 110, memory 112, communication interface 114, user interface 116, or UI control circuitry 122 (shown in FIG. 1). Operation 602 may comprise causing calculation of a route in a map. The processor 110 may, for example, provide means for performing operation 602. Operation 604 may comprise receiving input indicating a location along the route and a user preference associated with avoidance of the location, wherein the user preference includes a desired degree of avoidance of the location. The processor 110, user interface 116, and/or UI control circuitry 122 may, for example, provide means for performing operation 604. Operation 606 may comprise determining, based at least in part on the input, a modification to the route. The processor 110 may, for example, provide means for performing operation 606.

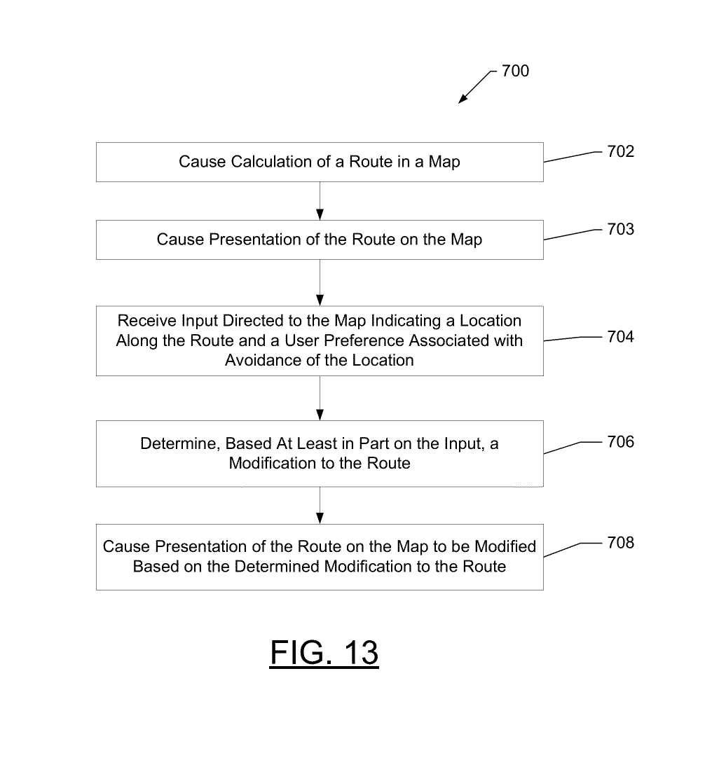

FIG. 13 illustrates a flowchart according to another example method for modification of routes based on user input according to an example embodiment 700. The operations illustrated in and described with respect to FIG. 13 may, for example, be performed by, with the assistance of, and/or under the control of one or more of the processor 110, memory 112, communication interface 114, user interface 116, or UI control circuitry 122 (shown in FIG. 1). Operation 702 may comprise causing calculation of a route in a map. The processor 110 may, for example, provide means for performing operation 702. Operation 703 may comprise causing presentation of the route on the map. The processor 110, user interface 116, and/or UI control circuitry 122 may, for example, provide means for performing operation 703. Operation 704 may comprise receiving input indicating a location along the route and a user preference associated with avoidance of the location. The processor 110, user interface 116, and/or UI control circuitry 122 may, for example, provide means for performing operation 704. Operation 706 may comprise determining, based at least in part on the input, a modification to the route. The processor 110 may, for example, provide means for performing operation 706. Operation 708 may comprise causing presentation of the route on the map to be modified based on the determined modification to the route. The processor 110, user interface 116, and/or UI control circuitry 122 may, for example, provide means for performing operation 708.

FIGS. 11-13 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
causing calculation of a route in a map;
receiving input indicating a location along the route and a user preference associated with avoidance of the location; and
determining, by a processor, based at least in part on the input, a modification to the route.

2. The method according to claim 1, wherein receiving input indicating the location along the route and the user preference associated with avoidance of the location comprises receiving input indicating a desired degree of avoidance of the location, and wherein determining the modification to the route comprises determining the modification to the route based at least in part on the desired degree of avoidance of the location.

3. The method according to claim 2, wherein receiving input comprises receiving user input comprising a point and twist gesture, and wherein a degree of the twist of the user input indicates the desired degree of avoidance of the location.

4. The method according to claim 2, wherein receiving input comprises receiving user input comprising at least one of a reverse pinch gesture or a slide gesture.

5. The method according to claim 1, wherein receiving input indicating the location along the route and the user preference associated with avoidance of the location comprises receiving input indicating at least one of a desired point of interest to pass by or a desire to travel on a road that includes less traffic.

6. The method according to claim 1, wherein determining the modification to the route comprises determining a modification to a portion of the route within a proximity of the location, wherein the proximity is determined based on the user preference associated with avoidance of the location.

7. The method according to claim 1 further comprising prompting the user to indicate a desired degree of avoidance of the location in response to receiving the input, and wherein determining the modification to the route further comprises determining the modification to the route based at least in part on the desired degree of avoidance of the location.

8. The method according to claim 1 further comprising, in response to receiving the input, causing display of a list of available modified routes for the user to select from.

9. The method according to claim 1 further comprising:
causing presentation of the route on the map; and
causing presentation of the route on the map to be modified based on the determined modification to the route.

10. An apparatus comprising at least one processor and at least one memory including computer program code, the memory and the computer program code configured to, with the at least one processor, cause the apparatus to:
cause calculation of a route in a map;
receive input indicating a location along the route and a user preference associated with avoidance of the location; and
determine, based at least in part on the input, a modification to the route.

11. The apparatus of claim 10, wherein the at least one memory and the computer program code are further configured to, with the at least one processor, cause the apparatus to receive input indicating the location along the route and the user preference associated with avoidance of the location by receiving input indicating a desired degree of avoidance of the location, and wherein the at least one memory and the computer program code are further configured to, with the at least one processor, cause the apparatus to determine the modification to the route by determining the modification to the route based at least in part on the desired degree of avoidance of the location.

12. The apparatus of claim 11, wherein the at least one memory and the computer program code are further configured to, with the at least one processor, cause the apparatus to receive input by receiving user input comprising a point and twist gesture, and wherein a degree of the twist of the user input indicates the desired degree of avoidance of the location.

13. The apparatus of claim 11, wherein the at least one memory and the computer program code are further configured to, with the at least one processor, cause the apparatus to receive input directed to the map indicating the user's desire to avoid the location by receiving user input comprising at least one of a reverse pinch gesture or a slide gesture.

14. The apparatus of claim 10, wherein the at least one memory and the computer program code are further configured to, with the at least one processor, cause the apparatus to receive input indicating the location along the route and the user preference associated with avoidance of the location by receiving input indicating at least one of a desired point of interest to pass by or a desire to travel on a road that includes less traffic.

15. The apparatus of claim 10, wherein the at least one memory and the computer program code are further configured to, with the at least one processor, cause the apparatus to determine the modification to the route by determining a modification to a portion of the route within a proximity of the location, wherein the proximity is determined based on the user preference associated with avoidance of the location.

16. The apparatus of claim 10, wherein the at least one memory and the computer program code are further configured to, with the at least one processor, cause the apparatus to prompt the user to indicate a desired degree of avoidance of the location in response to receiving the input, and wherein the at least one memory and the computer program code are further configured to, with the at least one processor, cause the apparatus to determine the modification to the route by determining the modification to the route based at least in part on the desired degree of avoidance of the location.

17. The apparatus of claim 10, wherein the at least one memory and the computer program code are further configured to, with the at least one processor, cause the apparatus to, in response to receiving the input, cause display of a list of available modified routes for the user to select from.

18. The apparatus of claim 10, wherein the at least one memory and the computer program code are further configured to, with the at least one processor, cause the apparatus to:
cause presentation of the route on the map; and
cause presentation of the route on the map to be modified based on the determined modification to the route.

19. Computer program product comprising a non-transitory computer readable medium having program code portions stored thereon, the program code portions being a computer readable medium and configured when said program product is run on a computer or network device, to:
cause calculation of a route in a map;
receive input indicating a location along the route and a user preference associated with avoidance of the location; and
determine, based at least in part on the input, a modification to the route.

20. The computer program product of claim 19, wherein the program code portions are further configured, when said program product is run on a computer or network device, to receive input indicating the location along the route and the user preference associated with avoidance of the location by receiving input indicating a desired degree of avoidance of the location, and wherein the program code portions are further configured, when said program product is run on a computer or network device, to determine the modification to the route by determining the modification to the route based at least in part on the desired degree of avoidance of the location.
